(19) United States
(12) Patent Application Publication
(10) Pub. No.: US 2015/0162150 A1
(43) Pub. Date: Jun. 11, 2015

(54) AMF CONTACT FOR VACUUM INTERRUPTER WITH INFORCEMENT ELEMENT

(71) Applicant: ABB TECHNOLOGY AG, Zurich (CH)

(72) Inventors: Alexey Sokolov, Baden (CH); Dietmar Gentsch, Ratingen (DE); Felix Rager, Kleindottingen (CH); Tarek Lamara, Confignon (CH); Thierry Delachaux, Zurich (CH)

(73) Assignee: ABB TECHNOLOGY AG, Zurich (CH)

(21) Appl. No.: 14/567,582

(22) Filed: Dec. 11, 2014

(30) Foreign Application Priority Data
Dec. 11, 2013 (EP) 13005772.2

(51) Int. Cl. H01H 33/664; H01H 9/44

(52) U.S. Cl. CPC H01H 33/664; H01H 9/44

(57) ABSTRACT

An AMF contact for a vacuum interrupter includes concentric opposing contact pieces. The contact pieces include an external electrode shaped like a coil with a plate as a bottom plate of the external electrode, which generates a strong axial magnetic field, and an inner internal electrode as a top electrode carrying the nominal current. To enable the outer electrode to generate the axial magnetic field as requested for an application, a rod is arranged between the top electrode and the bottom plate. A first end of the rod is fixed at a lower side of the top electrode, and a second end of the rod is guided through an opening of the bottom plate. The second end of the rod has an extended head which locks or tightens the rod in a defined axial position. The disclosed embodiments are applicable for standard AMF or TMF (cup) contacts to reinforce them.

### RELATED APPLICATION

This application claims priority to European Application 13005772.2 filed in Europe on Dec. 11, 2013. The entire content of this application is hereby incorporated by reference in its entirety.

### FIELD

The present disclosure relates to an axial magnetic field (AMF) contact for a vacuum interrupter. More particularly, the present disclosure relates to an AMF contact with concentric opposing contact pieces, wherein the contact pieces have an external electrode shaped like a coil and generating a strong axial magnetic field, and an inner internal electrode, carrying the nominal current.

### BACKGROUND INFORMATION

In the case of current interruption, a breaker should be able to pass successfully an O-C-O operation, i.e. to make under the fault current (C operation) and still to be able to reopen for the second break operation (second O operation). Vacuum interrupters have shown that during the making operation, the electrode might weld. This weld force, which should be broken to operate the O-C-O successfully, can be as high as 4-15 kN for CuCr25-45 contacts.

Preliminary tests of the mechanical strength of the outer electrode have shown that it is rather weak. A force of only ˜400 N already starts to deform plastically, which means permanent deformation of the electrode. This requests an action for mechanical reinforcement of the outer electrode, if we want to be able to operate repetitively and reliably successful O-C-O operations (open-close-open).

FR 2 946 791-A1 discloses a mechanical reinforcement rod located between the electrode and the bottom support plate of a “standard” AMF electrode; “standard” means single electrode contact. According to t FR 2 946 791-A1, the rod can have a high electrical resistivity so that a negligible current flows through it in comparison to the current flowing into the coil. It is also mentioned in this document that the rod can be composed of a hollow metallic tube filled by a ceramic material.

The rod is there to reinforce mechanically the electrode in order to avoid the collapse of the top part during closing operations. This technical application goes in the direction of a generator circuit- or high voltage breaker, where a large diameter electrode is necessary to interrupt the fault current.

The present disclosure is directed to the opposite object, that is, to provide a mechanical reinforcement solution in case of opening and breaking of the weld.

### SUMMARY

An exemplary embodiment of the present disclosure provides an AMF contact for a vacuum interrupter. The exemplary AMF contact includes concentric opposing contact pieces, where the contact pieces includes (i) an external electrode shaped like a coil with a plate constituting a bottom plate of the external electrode, the external electrode being configured to generate a strong axial magnetic field, and (ii) an inner internal electrode as a top electrode configured to carry a nominal current of the vacuum interrupter. The exemplary AMF contact also includes a rod arranged between the top electrode and the bottom plate. A first end is fixed at a lower side of the top electrode, and a second end of the rod, which is opposite the first end of the rod, is guided through an opening of the bottom plate. At the second end of the rod, the rod has an extended head, which is configured to at least one of lock and tighten the rod in a defined axial position.

### BRIEF DESCRIPTION OF THE DRAWINGS

Additional refinements, advantages and features of the present disclosure are described in more detail below with reference to exemplary embodiments illustrated in the drawings, in which:

FIG. 1 illustrates an exemplary embodiment of a contact piece with an upper part and a lower part;

FIG. 2a illustrates an exemplary embodiment of a contact piece with a view of the rod, in case of compression of the upper contact part;

FIG. 2b illustrates an example of a contact piece with an internal view of the rod, in case of tension of the upper contact part;

FIG. 3 illustrates an exemplary embodiment of a rod with an insulating coating;

FIG. 4 illustrates an exemplary embodiment of a hollow rod;

FIG. 5 illustrates an example of a rod with an insulating washer;

FIG. 6 illustrates an exemplary embodiment of an opening for a rod with insulating feed trough;

FIG. 7 illustrates an exemplary embodiment of a rod with an insulating washer and spring;

FIG. 8 illustrates an exemplary embodiment of an insulating technique according to the present disclosure;

FIG. 9 illustrates an exemplary embodiment of an insulating technique according to the present disclosure;

FIG. 10 illustrates an exemplary embodiment of an insulating technique according to the present disclosure;

FIG. 11 illustrates an exemplary embodiment of an insulating technique according to the present disclosure;

FIG. 12 illustrates an exemplary embodiment of an insulating technique according to the present disclosure; and

FIG. 13: Further alternative

### DETAILED DESCRIPTION

Exemplary embodiments of the present disclosure provide an AMF contact for a vacuum interrupter, with concentric opposing contact pieces. The contact pieces include (e.g., consist of) an external electrode shaped like a coil with a plate as a bottom plate of the electrode which generates a strong axial magnetic field, and an inner internal electrode as a top electrode which carries the nominal current. According to an exemplary embodiment, the outer electrode is designed in order to generate the axial magnetic field as requested for an application, with potentially superior performances to known configurations.

According to an exemplary embodiment, a rod is arranged between the top electrode and the bottom plate. The rod is at one end fixed at that lower side of the top electrode, and the other end of the rod is guided through an opening of the bottom plate, wherein at that end of the rod, the rod is furnished with an extended head such that the extended head of the rod locks or tightens the rod in a defined axial position.

In accordance with an exemplary embodiment, the opening in the bottom plate is dimensioned to be commensurate with the diameter of the rod such that the opening allows the rod to freely slide through it. This is beneficial for impact forces into the top electrode, in order to allow for the impact of a force transmission of a compression or a tension force to the top electrode. In accordance with an exemplary embodiment, the axial position is variable, such that a pre-compression- or pre-tension force can be impacted on the top electrode via the rod, such as the axial rod position, for example.

According to an exemplary embodiment, the rod is made of an insulating material or a material with low electrical conductivity.

According to an alternative exemplary embodiment, the rod is made of a metal core with an insulting surface passivation.

The AMF or also the TMF (especially cup shaped) standard contact system are reinforced by the use of the pin between the upper and the bottom plate of the contact part.

In accordance with an exemplary embodiment, the insulating surface passivation is made of ceramic.

According to an exemplary embodiment, the ceramic insulating material of the base can be made of AL₂O₃, ZrO₂, Y₂O₃. These ceramics have a high mechanical withstand and they are non-conductive.

According to an exemplary embodiment, the rod is metal and has an outer diameter dimensioned relative to the inner diameter of the opening in the bottom plate such that it leaves an insulating ring space between the outer surface of the rod and the inner surface of the opening. Further, the head of the rod is isolated against the bottom plate by a washer made of an insulating material.

According to an exemplary embodiment, a spring is arranged between the extended head of the rod and the insulating washer.

In accordance with an exemplary embodiment using the metal rod, the inner surface of the opening in the bottom plate is covered by a feed-through element made of insulating material.

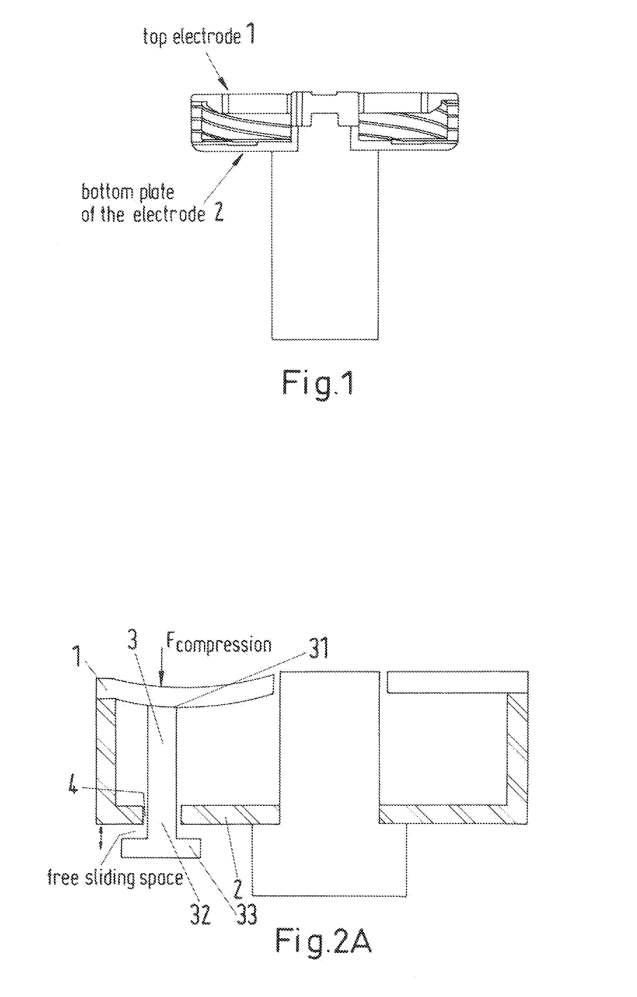

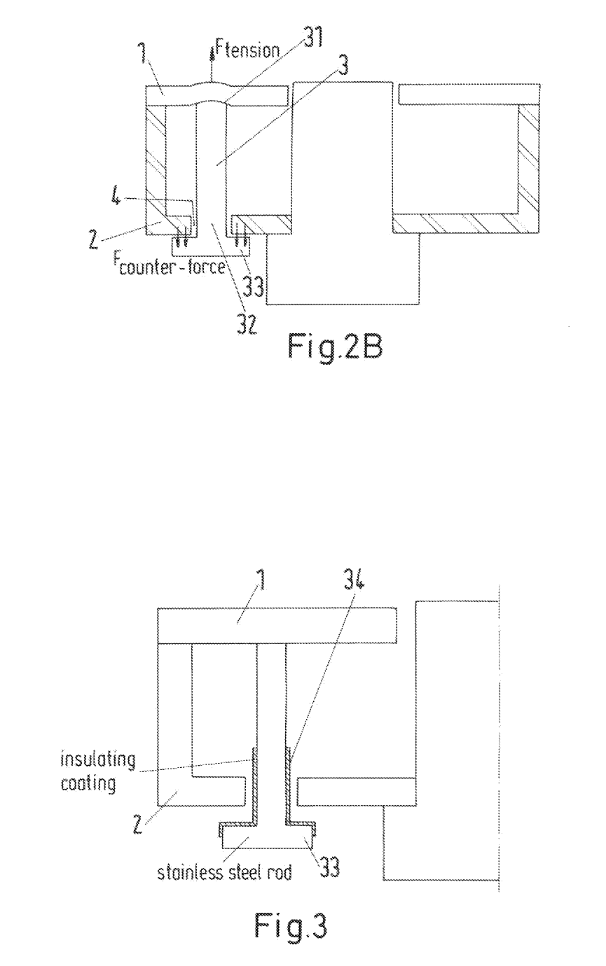

According to an exemplary embodiment illustrated in FIGS. 1 and 2A-2B, a screw or a rod 3 made of an insulating or relatively low electrical conductivity material is fixed (e.g., screwed or brazed) to the top electrode 1. The head of the rod 3 can slide freely when the top electrode 1 is compressed, but acts as a counter-force when the top electrode 1 is subject to a tension force, such as a weld force for example, as shown in FIG. 2B. In addition, the rod 3, which can be a metallic pin part, for example, can be fixed to be arranged between the bottom part of the contact system and the contact plate but will be coated or covered by the described ceramic layer.

A relatively low electrical conductivity material means that the conductivity of the material is relative to the conductivity of the coil material.

That is, the case of stainless steel screw or rod for a copper coil, for instance.

Exemplary insulating materials include ceramic material such as alumina, i.e. Al₂O₃, which is adequate for vacuum application due to low degassing, or zirconia, i.e. ZrO₂ (Yttrium stabilized) which can have high toughness properties to limit potential crack formation, Si₃N₄ and possibly other insulating materials.

FIG. 2A shows a system acting in compression. The insulating or relatively low electrical conductivity screw/rod 3 can move vertically without mechanical stresses, and for this design, the travel is maximum 1 mm.

In FIG. 2B, the system is shown in tension; the ceramic screw/rod 3 prevents the coil elongation.

The screw or rod made of an insulating or relatively low electrical conductivity material can be replaced by alternative solutions with the same concept of “slide through” and counter-force acting in tension.

The present disclosure provides the following exemplary solutions.

A metallic screw/rod 3 coated with an insulating material like a ceramic. The coating can essentially be on every part which could contact the bottom plate of the electrode (region of the screw head) (see FIG. 3). The coating can be thicker than 1-10 micrometers, where 10 micrometers is the order of magnitude.

According to an exemplary embodiment, the screw or rod 3 can be made of a material with good mechanical properties (yield strength) such as stainless steel, for example.

Exemplary coating insulating material can be Al₂O₃, ZrO₂ (Yttrium stabilized), etc.

The coatings can be prepared by various deposition technics on stainless steel rod/screws or on other metals. Exemplary methods include plasma spraying, PVD, CVD, PECVD, etc.

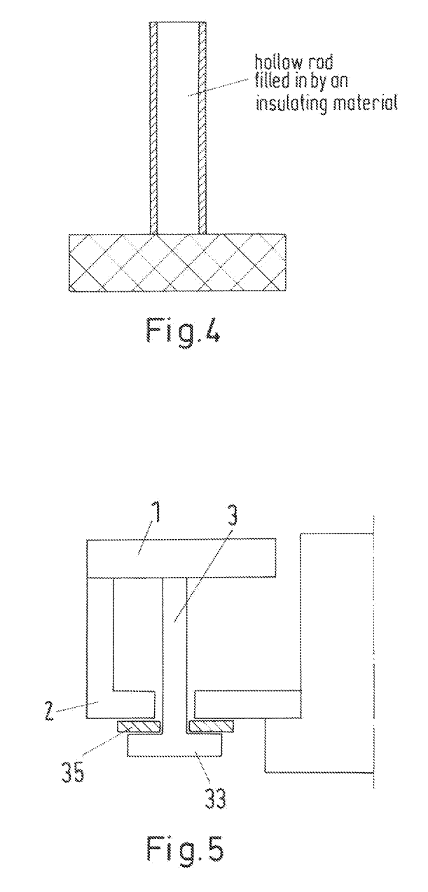

An exemplary alternative is a hollow metal screw/rod filled in by a ceramic/relatively low electrical conductivity material, see FIG. 4. This can also be an insulating material (ceramic) coated by a thin metallic layer like stainless steel for a few micro-meters.

Another exemplary alternative is a metallic screw/rod with an insulating/relatively low electrical conductivity washer. The washer can be made of a metallic material coated with an insulator film such as ceramic materials (e.g., Al₂O₃, ZrO₂ (Yttrium stabilized)). The “slide-through” hole should be large enough, so that the metallic screw/rod does not touch the side of the electrode, which could create a conductive path. See FIG. 5.

FIG. 5 shows a metallic screw/rod 3 with an insulating/relatively low electrical conductivity washer 35 interposed between the head 33 of the screw/rod 3 and the bottom plate of the electrode 2. Several possible geometries can apply like the alternative on the right.

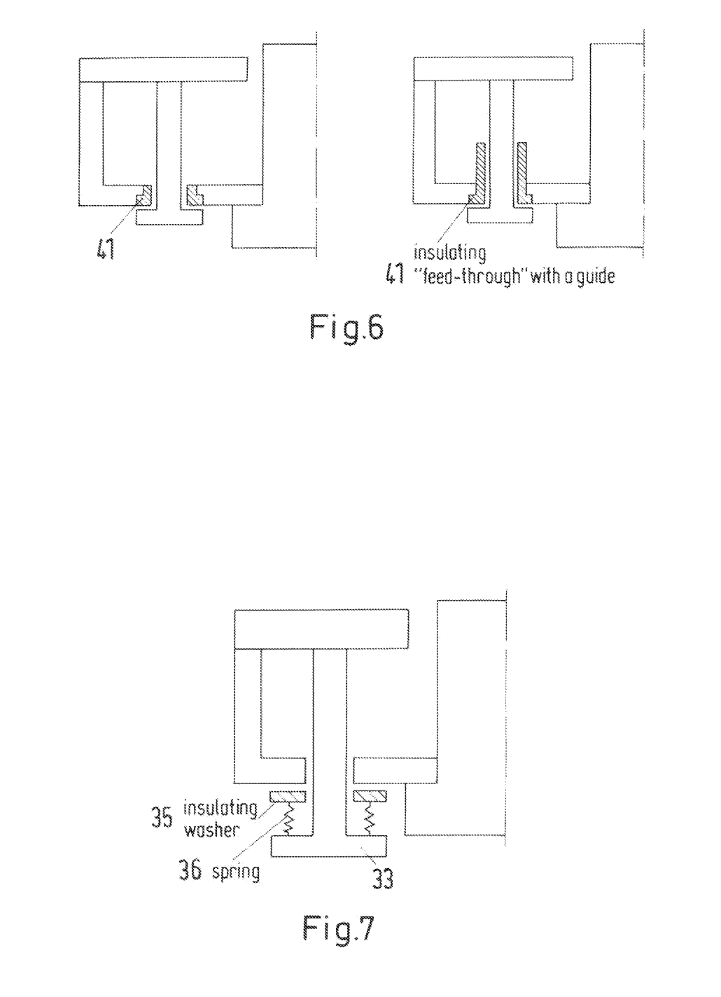

A metallic screw/rod with an insulating/relatively low electrical conductivity “feed-through” 41 around the bottom plate separating electrically the screw/rod from the bottom plate is shown in FIG. 6.

FIG. 6 shows a metallic screw/rod with an insulating/relatively low electrical conductivity “feed-through” 41 around the bottom plate of the electrode separating electrically the electrode from the screw/rod. The feed-through can be extended to guide the screw/rod (right drawing).

A metallic screw/rod with an insulating/relatively low electrical conductivity washer and a spring between the washer and the screw/rod head. The spring functionality could be to compensate mechanical placement in the mechanical construction and to absorb shocks, as shown in FIG. 7.

FIG. 7 shows a metallic screw/rod with an insulating/relatively low electrical conductivity washer 35 and a spring 36 between the washer 35 and the head 33 of the screw/rod.

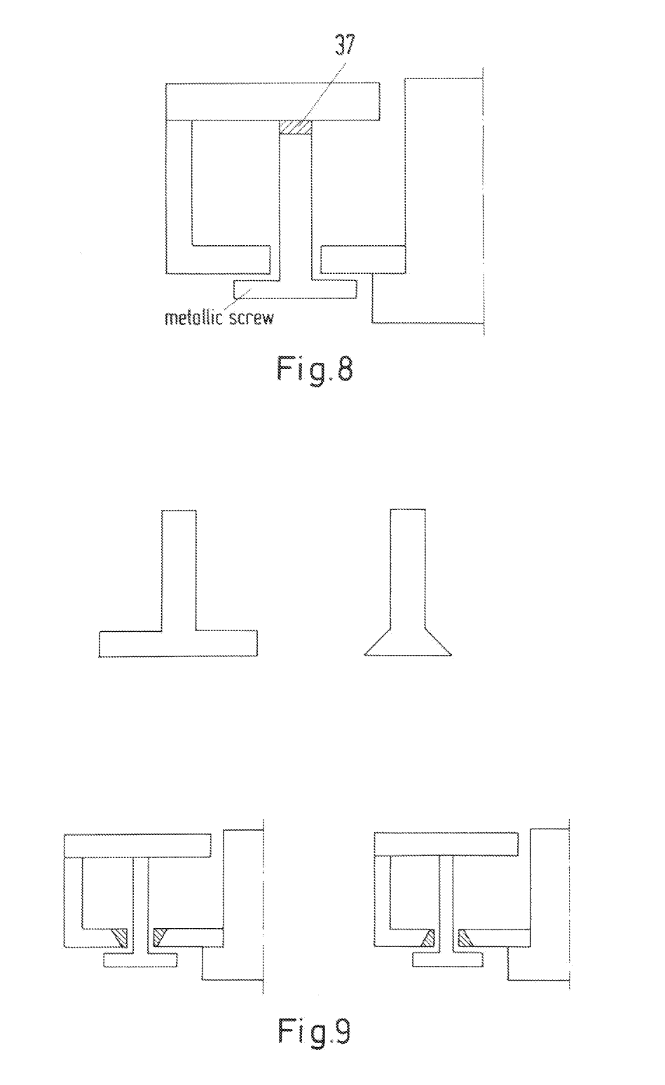

A metallic screw/rod with an insulating/relatively low electrical conductivity part 37 interposed between the top electrode and the screw/rod, similar to the exemplary embodiment shown in FIG. 8.

FIG. 8 illustrates a metallic screw/rod with an insulating/relatively low electrical conductivity section (here on top of the screw/rod).

Special shapes, essentially in form of cones, for the head screw/rod and for the feed-through can be designed in order to minimize the mechanical stresses when the counter-force is applied, like shown in FIG. 9. Other geometries can be possible too.

FIG. 9 shows illustrations of screw/rod with special head shapes (right), and different shapes of the “insulating/low electrical conductivity “feed-through”.

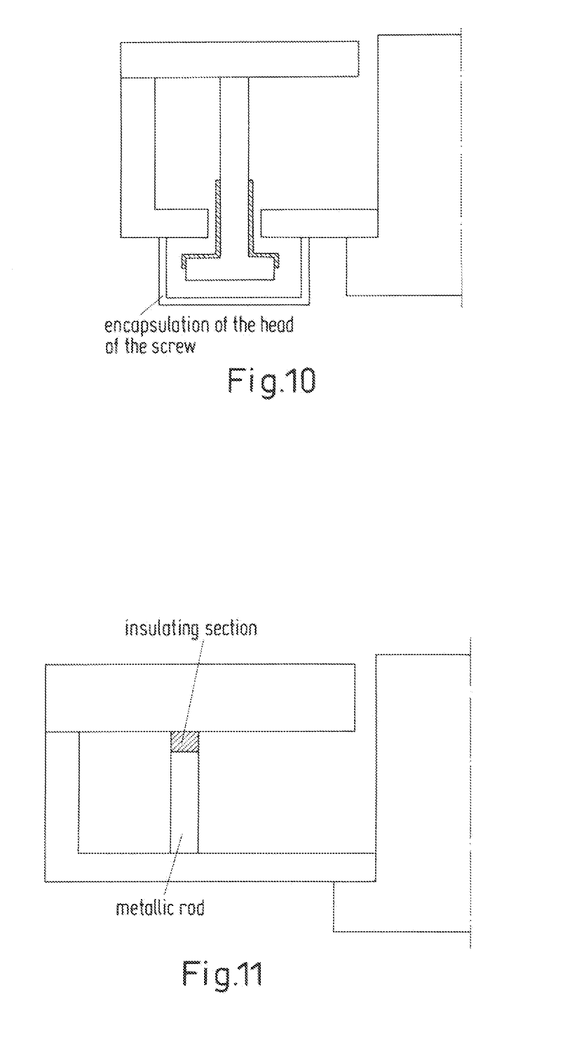

A special add-on enclosing the screw/rod head is considered as a solution to capture possible micro-particles of the insulating/relatively low electrical conductivity material which can be lost by either friction on the electrode or by repeated mini-shocks compression. The solution is envisioned to keep the dielectric strength at high value, as shown in FIG. 10.

FIG. 10 shows illustrations of an encapsulating add-on around the head of the screw/rod.

The next set of solutions does not require any sliding part. It is fixed inside the electrode between the top electrode and bottom plate:

According to an exemplary embodiment, a metallic rod can contain at least one portion of insulating/relatively low electrical conductivity material. This portion can be as thin as a coating of several μm, as shown in FIG. 11.

FIG. 11 shows a metallic rod with an insulating/relatively low conducting section (here on the top of the rod).

According to an exemplary embodiment, a hollow metallic rod can contain an insulating/low electrical conductivity material, as shown in FIG. 12.

FIG. 12 shows a hollow metallic rod filled with an insulating/relatively low conducting material.

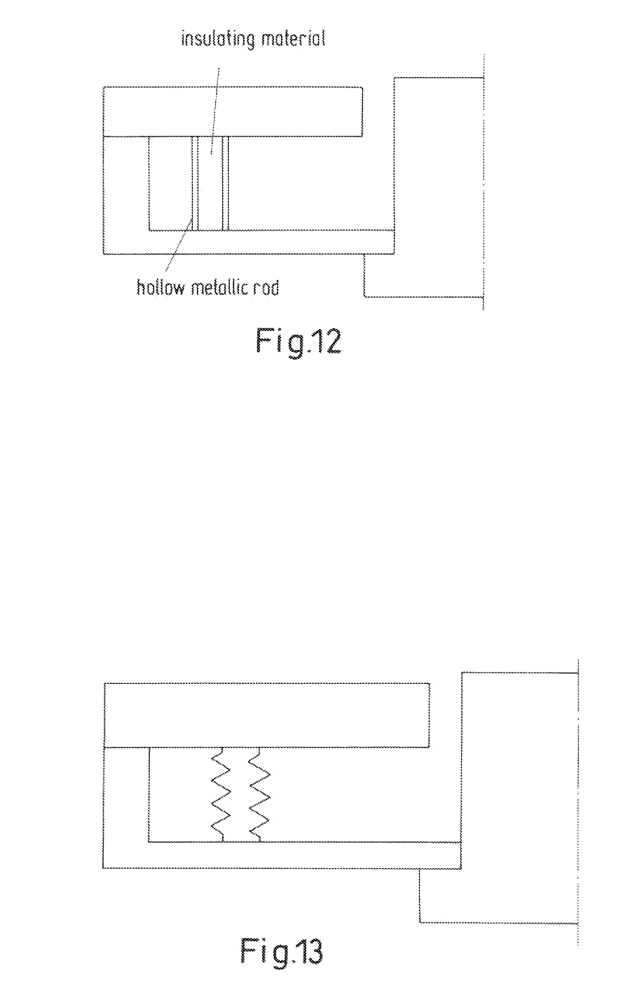

According to an exemplary embodiment, a spring can be provided with a strong spring constant to counter-act the tensile force (weld force), as shown in FIG. 13.

According to an exemplary embodiment, a ceramic ring can be placed between the top electrode and the bottom plate.

According to an exemplary embodiment, a metallic ring thick enough (˜5 mm) to sustain the tensile force (weld force) can be provided. The metal can be, for example, stainless steel or another high yield strength material. In the case of a stainless steel electrode, the ring can be bored in order to reduce its electrical resistance to acceptable value, i.e. carrying less than 10% of nominal current. The ring can be shaped in order to produce an axial magnetic field as well.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### Numbers

1 top electrode
2 bottom electrode
3 rod
4 opening
31 top end of the rod
32 bottom end of the rod
33 rod head
34 insulating coating of the rod
35 insulating washer
36 spring
37 insulating element
41 insulating feed-through

What is claimed is:

1. An AMF contact for a vacuum interrupter, the AMF contact comprising: concentric opposing contact pieces, the contact pieces including
an external electrode shaped like a coil with a plate constituting a bottom plate of the external electrode, the external electrode being configured to generate a strong axial magnetic field, and
an inner internal electrode as a top electrode configured to carry a nominal current of the vacuum interrupter;
a rod arranged between the top electrode and the bottom plate,
wherein a first end is fixed at a lower side of the top electrode, and a second end of the rod, which is opposite the first end of the rod, is guided through an opening of the bottom plate, and
wherein at the second end of the rod, the rod has an extended head, which is configured to at least one of lock and tighten the rod in a defined axial position.

2. The AMF contact according to claim 1, wherein the opening in the bottom plate is dimensioned commensurate with a diameter of the rod such that the opening allows the rod to slide freely therethrough.

3. The AMF contact according to claim 1, wherein an axial position of the rod is variable such that a pre-compression or pre-tension force can be impacted on the top electrode via the rod.

4. The AMF contact according to claim 1, wherein the rod is comprised of an insulating material.

5. The AMF contact according to claim 1, wherein the rod is comprised of a material with a low electrical conductivity.

6. The AMF contact according to claim 1, wherein the rod is comprised of a metal core with an insulting surface passivation.

7. The AMF contact according to claim 1, wherein the rod is configured to reinforce an AMF or TMF standard contact system between upper and bottom plate of contact parts.

8. The AMF contact according to claim 6, wherein the insulating surface passivation is made of ceramic.

9. The AMF contact according to claim 6, wherein the ceramic insulating material of the surface passivation is made of one of AL2O3, ZrO2 and Y2O3.

10. The AMF contact according to claim 1, wherein an outer diameter of the rod is dimensioned relative to an inner diameter of the opening in the bottom plate such that the rod leaves an insulating ring space between the outer surface of the rod and the inner surface of the opening, and
wherein the head of the rod is isolated against the bottom plate by a washer made of an insulating material.

11. The AMF contact according to claim 1, comprising:
a spring arranged between the extended head of the rod and the insulating washer.

12. The AMF contact according to claim 1, wherein an inner surface of the opening in the bottom plate is covered by a feed-through element made of insulating material.
